(19) United States
(12) Patent Application Publication
(10) Pub. No.: US 2022/0416997 A1
(43) Pub. Date: Dec. 29, 2022

(54) HANDLING UNALIGNED TRANSACTIONS FOR INLINE ENCRYPTION

(71) Applicant: Intel Corporation, Santa Clara, CA (US)

(72) Inventors: Prashant Dewan, Portland, OR (US); Siddhartha Chhabra, Portland, OR (US); Robert J. Royer, JR., Portland, OR (US); Michael Glik, Kfar Saba M (IL); Baiju Patel, Portland, OR (US)

(73) Assignee: Intel Corporation, Santa Clara, CA (US)

(21) Appl. No.: 17/357,973

(22) Filed: Jun. 24, 2021

(51) Int. Cl. H04L 9/06; G06F 21/72

(52) U.S. Cl. CPC H04L 9/0631; G06F 21/72; H04L 2209/12

(57) ABSTRACT

Methods and apparatus relating to handling unaligned transactions for inline encryption are described. In an embodiment, cryptographic logic circuitry receives a plurality of incoming packets and store two or more incoming packets from the plurality of incoming packets in memory. The cryptographic logic circuitry is informs software in response to detection of the two or more incoming packets. Other embodiments are also disclosed and claimed.

### FIELD

The present disclosure generally relates to the field of electronics. More particularly, an embodiment relates to handling unaligned transactions for inline encryption.

### BACKGROUND

Advanced Encryption Standard (AES) encryption is widely used in computing to encrypt data. AES encryption supports multiple modes, but all these modes currently force the encryption to a specific block size of 16 bytes. This implies in a streaming traffic if the transactions are either not aligned to 16 bytes or the size of the data in the transaction is not a multiple of 16 bytes, the AES engine cannot encrypt or decrypt the traffic. This becomes a problem if the hardware has to halt the traffic in order to collect 16 bytes or if the bytes are out-of-order.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates an apparatus for inline encryption of aligned transactions, which may be utilized in an embodiment.

FIG. 2 illustrates a system for inline encryption of unaligned and/or fragmented transactions, according to an embodiment.

FIG. 3 illustrates a flow diagram of a method to handle unaligned transactions for inline encryption, according to an embodiment.

FIG. 4 illustrates a block diagram of an SOC (System On Chip) package in accordance with an embodiment.

FIG. 5 is a block diagram of a processing system, according to an embodiment.

FIG. 6 is a block diagram of an embodiment of a processor having one or more processor cores, according to some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, if the hardware has to halt the traffic in order to collect 16 bytes for an AES engine or if the bytes are out-of-order, this can cause problems with performance and/or security (since data may be exposed). Furthermore, many network and IO (Input/Output) bus standards do not put a requirement of alignment or size multiple on a sender. This can be a significant problem for inline encryption of network traffic and storage traffic over PCIe (Peripheral Component Interconnect express), Thunderbolt™, and other buses.

To this end, some embodiments provide one or more techniques to handling unaligned transactions for inline encryption. One or more embodiments may be applied to decryption of unaligned and encrypted transactions.

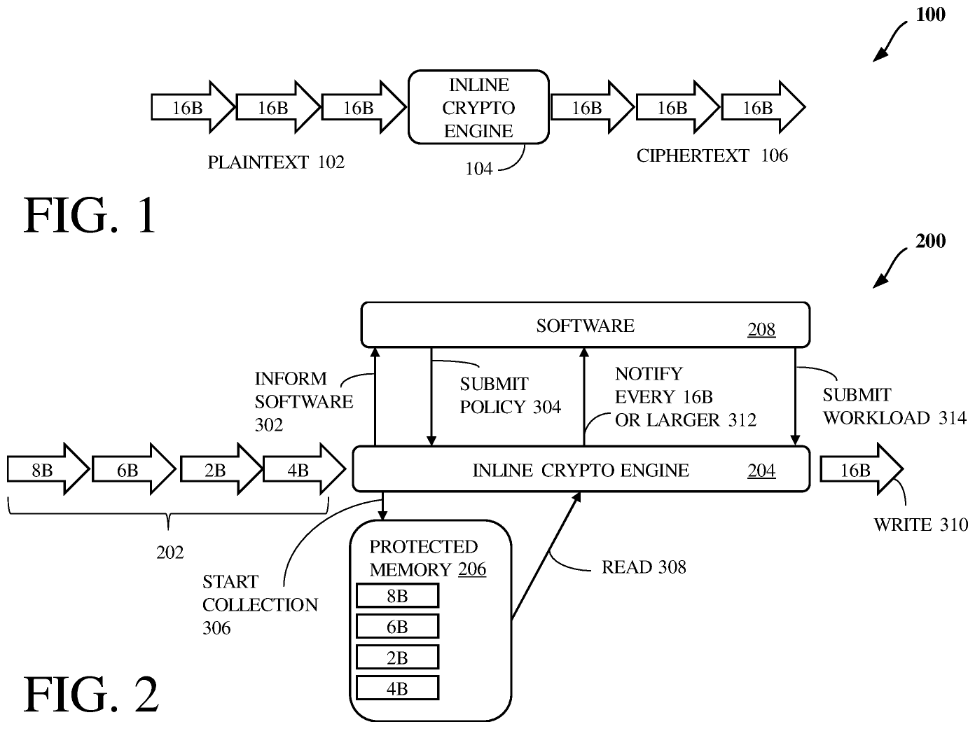

FIG. 1 illustrates an apparatus 100 for inline encryption of aligned transactions, which may be utilized in an embodiment. For encryption, plaintext data 102 is fed to the Inline Cryptographic Engine (ICE) 104 in 16 byte increments/transactions. The ICE 104 then encrypts the received transactions in order and outputs the encrypted data as ciphertext 106 in 16 byte chunks. For decryption, the flow shown in FIG. 1 may be reversed.

FIG. 2 illustrates a system 200 for inline encryption of unaligned and/or fragmented transactions, according to an embodiment. As shown in FIG. 2, granular traffic 202, directed at an Inline Cryptographic Engine (ICE) 204, which is not aligned to 16B is encrypted. The cryptographic (also interchangeably referred to herein as “crypto”) engine 204 takes the sub-16 byte(s) 202 and stores them in local memory 206 (such as in SRAM (Static Random Access Memory), MRAM (Magnetoresistive Random Access Memory), or in dedicated and protected DRAM (Dynamic Random Access Memory)). In one embodiment, memory 206 is only accessible to the ICE 204. Also, the sample sizes show for granular traffic 202 are only examples and embodiments are not limited to these values.

In an embodiment, when the ICE 204 starts storing the transaction bytes/packets in the memory 206, it may also record the transaction identifier of the incoming stream in the memory 206. As discussed herein, each transaction may include one or more packets that are transmitted in an incoming stream. Subsequently, the crypto engine 204 informs software 208 (which may be an operating system and/or software application) that the given transaction will be handled out-of-order. This provides the software an option to determine whether to ask the hardware (here ICE 204) to drop the rest of the transactions (following the unaligned transaction) or handle the out-of-order transactions while continuing the other transactions in the pipeline. Also, while some embodiments herein are discussed with reference to 16B packets, embodiments are not limited to this specific size and incoming packets may have a different size, which may be determined at boot time and/or design time, for example.

If the software specifies that processing of the rest of the pipeline can continue, the AES engine (e.g., implemented as part of ICE 204, not shown) keeps on collecting the ciphertext (for decryption) or the plaintext (for encryption) of the specific transaction identifier in the local buffer or memory 206, while processing the rest of the transactions as discussed with reference to FIG. 1.

As soon as the ICE 204 receives 16 or more contiguous bytes of the transaction, it processes them and writes the result to memory accessible by the software 208. Subsequently, ICE 204 may notify the software 208 that the 16 bytes are ready to be read by the software 208. The ICE hardware might further adjust its operations based on software request, and for example only notify software at a higher granularity, in order not to interrupt the operations of software on every 16 bytes. If the software specifies that the rest of the pipeline is to be flushed, the hardware drops all the packets belonging to the subsequent transactions after the specific transaction and optionally notifies the sender to abort sending more packets. When the ICE hardware is able to process all the bytes from the transaction, it may send a signal or otherwise interrupt the software. Software can now restart the data stream by sending new transactions to the device providing the data stream 202 if needed. While encryption of an incoming stream 202 is generally discussed above, the same process may also be applied to decryption, i.e., incoming encrypted data in transactions with lower than 16B size, temporary stored in memory 206, decrypted after 16B chuck of data is received and communicated with the software.

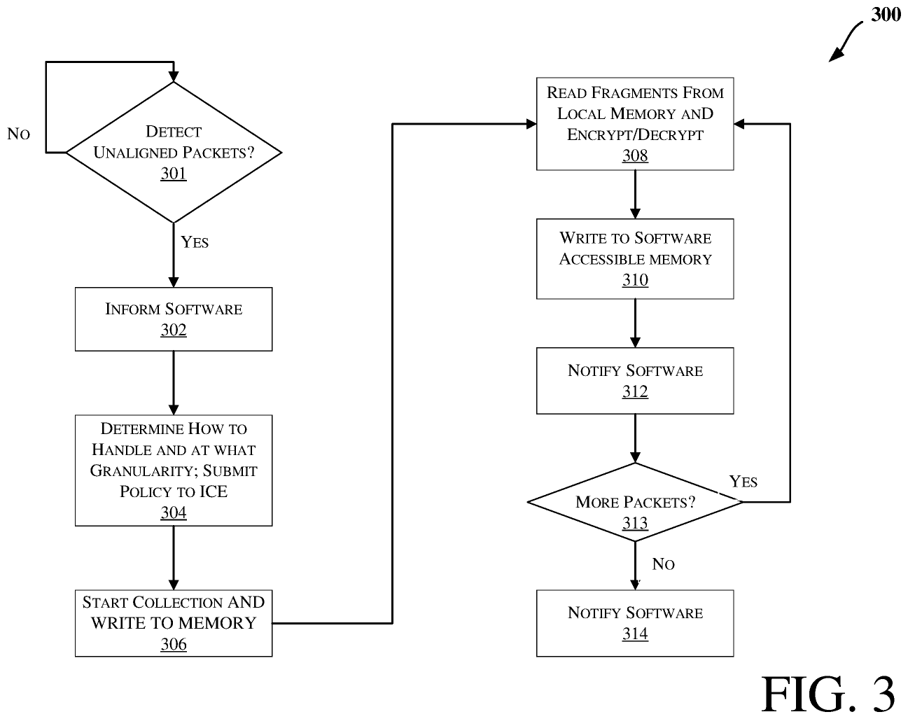

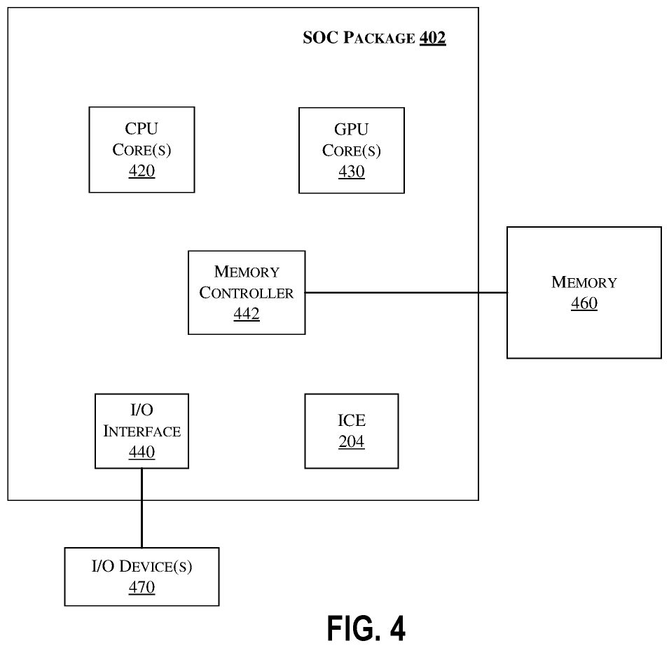

FIG. 3 illustrates a flow diagram of a method 300 to handle unaligned transactions for inline encryption, according to an embodiment. In one or more embodiments, operations of the method 300 may be performed by one of more hardware components of FIG. 2 and/or FIG. 4 et seq. as further discussed below.

In an embodiment, method 300 manages fragmented and/or unaligned transactions and supplies the choice to software to decide on how they should be managed. Allowing software to specify the policy addresses the situations where the inline crypto engine is unaware of cross-dependencies of the transaction data. Whereas the software that is managing the crypto engine is aware of the cross-dependencies of the transactions and can handle out-of-order transactions. Hence, the encryption hardware is putting the responsibility of re-aligning the out-of-order transactions on the software.

In many scenarios, like storage transaction scenarios, if the incoming transactions pertain to two different files, software can easily handle them out-of-order. Even with the same file, different blocks can be managed by software. However, the hardware does not have the information to manage it. In a network scenario, out-of-order transactions can be managed by software when these transactions belong to different networks streams or network sockets.

Furthermore, some embodiments allow an inline crypto engine to work with a variety of traffic senders (e.g., Non-Volatile Memory express (NVMe) drives, network devices, Thunderbolt devices, etc.) without having to change the system. As would be appreciated, changing the system can be an expensive and a time-consuming proposition and would affect the ability to deliver innovation in time.

Referring to FIGS. 2-3, at an operation 301, ICE 204 detects the size of the incoming data packets. Once unaligned packets are detected (e.g., having a size below 16B for AES), ICE 204 informs software 208 about the detected unaligned transaction at operation 302 (e.g., by sending the transaction identifier associated with the detected unaligned transaction to the software).

At operation 304, software 208 determines whether it can or should handle this transaction in an out-of-order fashion. In addition, software 208 decides at what granularity it needs the hardware to handle the transaction and informs the ICE 204 as the rest of the packets arrive. Hence, software 208 submits the notification granularity and the policy to the ICE at operation 304.

At operation 306, ICE 204 starts collecting the fragmented packets in protected memory (not accessible to the software 208 and/or any other entities other than ICE 204). This memory may be an (e.g., internal) SRAM, MRAM, or DRAM, which may be allocated by software 208 but not readable/writable by software 208.

At operation 308, once 16 bytes are collected in the protected memory, ICE 204 reads the 16B of plaintext (for encryption or ciphertext for decryption) from the protected memory 206, encrypts (or decrypts) it.

At operation 310, ICE 204 writes the encrypted (or decrypted) bytes to a software accessible memory (not shown). In an embodiment, ICE 204 also frees up the 16B in the protected memory that has been written. If the policy specified by software at operation 304 requests a higher granularity than 16B, ICE honors this at operation 310 and only writes to memory when the appropriate number of bytes have been collected. Such an approach may provide efficiency as the software will not have to be interrupted for every 16 byte of data.

At an operation 312, ICE 204 notifies the software 208 that the encrypted/decrypted (e.g., 16B multiple) has been encrypted/decrypted and accessible by the software. Per operation 313, operations 308-312 are repeated until all packets in the transaction are processed.

At operation 314, once the transaction is complete, software 208 is free to submit the next workload. If software can handle out-of-order transactions, and operation 314 may be interleaved with other operations as well.

Additionally, some embodiments may be applied in computing systems that include one or more processors (e.g., where the one or more processors may include one or more processor cores), such as those discussed with reference to FIG. 1 et seq., including for example a desktop computer, a work station, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

FIG. 4 illustrates a block diagram of an SOC package in accordance with an embodiment. As illustrated in FIG. 4, SOC 402 includes one or more Central Processing Unit (CPU) cores 420, one or more Graphics Processor Unit (GPU) cores 430, an Input/Output (I/O) interface 440, and a memory controller 442. Various components of the SOC package 402 may be coupled to an interconnect or bus such as discussed herein with reference to the other figures. Also, the SOC package 402 may include more or less components, such as those discussed herein with reference to the other figures. Further, each component of the SOC package 402 may include one or more other components, e.g., as discussed with reference to the other figures herein. In one embodiment, SOC package 402 (and its components) is provided on one or more Integrated Circuit (IC) die, e.g., which are packaged into a single semiconductor device.

As illustrated in FIG. 4, SOC package 402 is coupled to a memory 460 via the memory controller 442. In an embodiment, the memory 460 (or a portion of it) can be integrated on the SOC package 402.

The I/O interface 440 may be coupled to one or more I/O devices 470, e.g., via an interconnect and/or bus such as discussed herein with reference to other figures. I/O device(s) 470 may include one or more of a keyboard, a mouse, a touchpad, a display, an image/video capture device (such as a camera or camcorder/video recorder), a touch screen, a speaker, or the like.

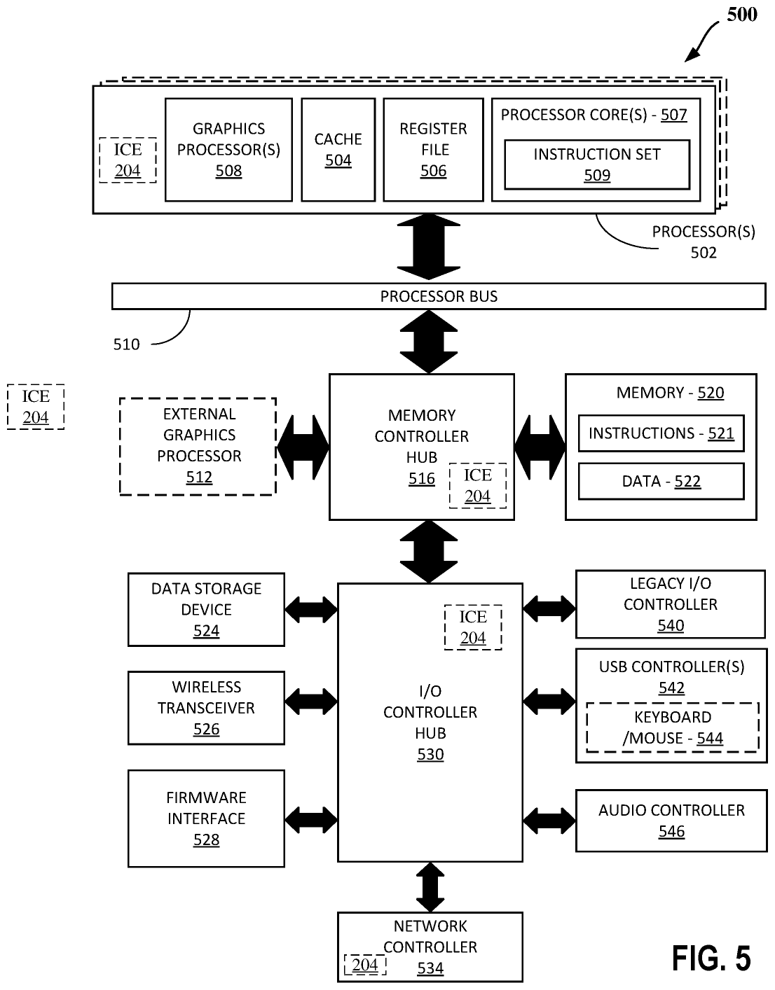

FIG. 5 is a block diagram of a processing system 500, according to an embodiment. In various embodiments the system 500 includes one or more processors 502 and one or more graphics processors 508, and may be a single processor desktop system, a multiprocessor workstation system, or a server system having a large number of processors 502 or processor cores 507. In on embodiment, the system 500 is a processing platform incorporated within a system-on-a-chip (SoC or SOC) integrated circuit for use in mobile, handheld, or embedded devices.

An embodiment of system 500 can include, or be incorporated within a server-based gaming platform, a game console, including a game and media console, a mobile gaming console, a handheld game console, or an online game console. In some embodiments system 500 is a mobile phone, smart phone, tablet computing device or mobile Internet device. Data processing system 500 can also include, couple with, or be integrated within a wearable device, such as a smart watch wearable device, smart eyewear device, augmented reality device, or virtual reality device. In some embodiments, data processing system 500 is a television or set top box device having one or more processors 502 and a graphical interface generated by one or more graphics processors 508.

In some embodiments, the one or more processors 502 each include one or more processor cores 507 to process instructions which, when executed, perform operations for system and user software. In some embodiments, each of the one or more processor cores 507 is configured to process a specific instruction set 509. In some embodiments, instruction set 509 may facilitate Complex Instruction Set Computing (CISC), Reduced Instruction Set Computing (RISC), or computing via a Very Long Instruction Word (VLIW). Multiple processor cores 507 may each process a different instruction set 509, which may include instructions to facilitate the emulation of other instruction sets. Processor core 507 may also include other processing devices, such a Digital Signal Processor (DSP).

In some embodiments, the processor 502 includes cache memory 504. Depending on the architecture, the processor 502 can have a single internal cache or multiple levels of internal cache. In some embodiments, the cache memory is shared among various components of the processor 502. In some embodiments, the processor 502 also uses an external cache (e.g., a Level-3 (L3) cache or Last Level Cache (LLC)) (not shown), which may be shared among processor cores 507 using known cache coherency techniques. A register file 506 is additionally included in processor 502 which may include different types of registers for storing different types of data (e.g., integer registers, floating point registers, status registers, and an instruction pointer register). Some registers may be general-purpose registers, while other registers may be specific to the design of the processor 502.

In some embodiments, processor 502 is coupled to a processor bus 510 to transmit communication signals such as address, data, or control signals between processor 502 and other components in system 500. In one embodiment the system 500 uses an exemplary ‘hub’ system architecture, including a memory controller hub 516 and an Input Output (I/O) controller hub 530. A memory controller hub 516 facilitates communication between a memory device and other components of system 500, while an I/O Controller Hub (ICH) 530 provides connections to I/O devices via a local I/O bus. In one embodiment, the logic of the memory controller hub 516 is integrated within the processor.

Memory device 520 can be a dynamic random access memory (DRAM) device, a static random access memory (SRAM) device, flash memory device, phase-change memory device, or some other memory device having suitable performance to serve as process memory. In one embodiment the memory device 520 can operate as system memory for the system 500, to store data 522 and instructions 521 for use when the one or more processors 502 executes an application or process. Memory controller hub 516 also couples with an optional external graphics processor 512, which may communicate with the one or more graphics processors 508 in processors 502 to perform graphics and media operations.

In some embodiments, ICH 530 enables peripherals to connect to memory device 520 and processor 502 via a high-speed I/O bus. The I/O peripherals include, but are not limited to, an audio controller 546, a firmware interface 528, a wireless transceiver 526 (e.g., Wi-Fi, Bluetooth), a data storage device 524 (e.g., hard disk drive, flash memory, etc.), and a legacy I/O controller 540 for coupling legacy (e.g., Personal System 2 (PS/2)) devices to the system. One or more Universal Serial Bus (USB) controllers 542 connect input devices, such as keyboard and mouse 544 combinations. A network controller 534 may also couple to ICH 530. In some embodiments, a high-performance network controller (not shown) couples to processor bus 510. It will be appreciated that the system 500 shown is exemplary and not limiting, as other types of data processing systems that are differently configured may also be used. For example, the I/O controller hub 530 may be integrated within the one or more processor 502, or the memory controller hub 516 and I/O controller hub 530 may be integrated into a discreet external graphics processor, such as the external graphics processor 512.

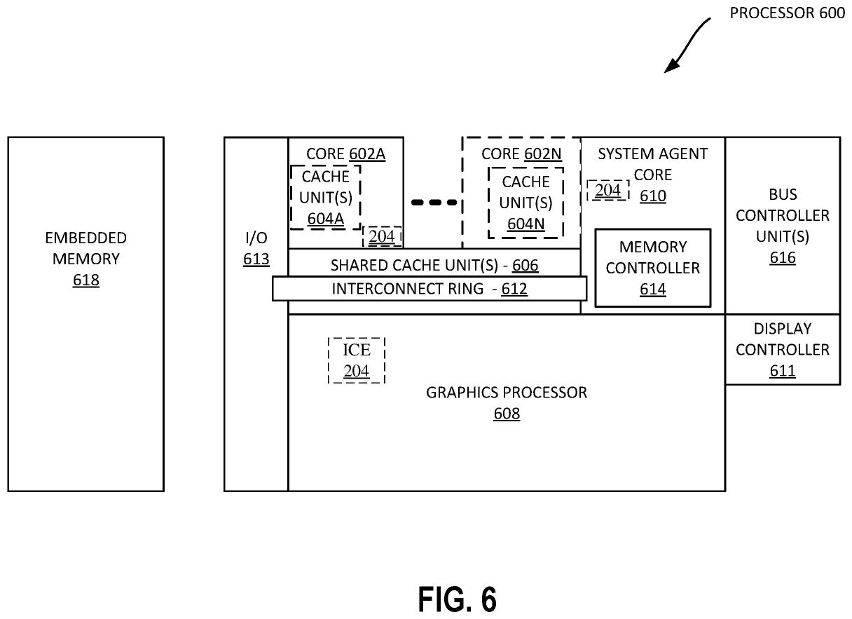

FIG. 6 is a block diagram of an embodiment of a processor 600 having one or more processor cores 602A to 602N, an integrated memory controller 614, and an integrated graphics processor 608. Those elements of FIG. 6 having the same reference numbers (or names) as the elements of any other figure herein can operate or function in any manner similar to that described elsewhere herein, but are not limited to such. Processor 600 can include additional cores up to and including additional core 602N represented by the dashed lined boxes. Each of processor cores 602A to 602N includes one or more internal cache units 604A to 604N. In some embodiments each processor core also has access to one or more shared cached units 606.

The internal cache units 604A to 604N and shared cache units 606 represent a cache memory hierarchy within the processor 600. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 606 and 604A to 604N.

In some embodiments, processor 600 may also include a set of one or more bus controller units 616 and a system agent core 610. The one or more bus controller units 616 manage a set of peripheral buses, such as one or more Peripheral Component Interconnect buses (e.g., PCI, PCI Express). System agent core 610 provides management functionality for the various processor components. In some embodiments, system agent core 610 includes one or more integrated memory controllers 614 to manage access to various external memory devices (not shown).

In some embodiments, one or more of the processor cores 602A to 602N include support for simultaneous multi-threading. In such embodiment, the system agent core 610 includes components for coordinating and operating cores 602A to 602N during multi-threaded processing. System agent core 610 may additionally include a power control unit (PCU), which includes logic and components to regulate the power state of processor cores 602A to 602N and graphics processor 608.

In some embodiments, processor 600 additionally includes graphics processor 608 to execute graphics processing operations. In some embodiments, the graphics processor 608 couples with the set of shared cache units 606, and the system agent core 610, including the one or more integrated memory controllers 614. In some embodiments, a display controller 611 is coupled with the graphics processor 608 to drive graphics processor output to one or more coupled displays. In some embodiments, display controller 611 may be a separate module coupled with the graphics processor via at least one interconnect, or may be integrated within the graphics processor 608 or system agent core 610.

In some embodiments, a ring based interconnect unit 612 is used to couple the internal components of the processor 600. However, an alternative interconnect unit may be used, such as a point-to-point interconnect, a switched interconnect, or other techniques, including techniques well known in the art. In some embodiments, graphics processor 608 couples with the ring interconnect 612 via an I/O link 613.

The exemplary I/O link 613 represents at least one of multiple varieties of I/O interconnects, including an on package I/O interconnect which facilitates communication between various processor components and a high-performance embedded memory module 618, such as an eDRAM (or embedded DRAM) module. In some embodiments, each of the processor cores 602 to 602N and graphics processor 608 use embedded memory modules 618 as a shared Last Level Cache.

In some embodiments, processor cores 602A to 602N are homogenous cores executing the same instruction set architecture. In another embodiment, processor cores 602A to 602N are heterogeneous in terms of instruction set architecture (ISA), where one or more of processor cores 602A to 602N execute a first instruction set, while at least one of the other cores executes a subset of the first instruction set or a different instruction set. In one embodiment processor cores 602A to 602N are heterogeneous in terms of microarchitecture, where one or more cores having a relatively higher power consumption couple with one or more power cores having a lower power consumption. Additionally, processor 600 can be implemented on one or more chips or as an SoC integrated circuit having the illustrated components, in addition to other components.

The following examples pertain to further embodiments. Example 1 includes an apparatus comprising: memory coupled to cryptographic logic circuitry; and the cryptographic logic circuitry to receive a plurality of incoming packets and store two or more incoming packets from the plurality of incoming packets in the memory, wherein the cryptographic logic circuitry is to inform software in response to detection of the two or more incoming packets. Example 2 includes the apparatus of example 1, wherein the memory is accessible by the cryptographic logic circuitry and inaccessible by the software. Example 3 includes the apparatus of example 1, wherein the software is to indicate to the cryptographic logic circuitry whether to drop one or more transactions to be received after the two or more incoming packets or to process the two or more incoming packets out-of-order and continue to process the one or more transactions. Example 4 includes the apparatus of example 1, the cryptographic logic circuitry is to receive the two or more incoming packets out-of-order. Example 5 includes the apparatus of example 1, wherein the cryptographic logic circuitry is to notify the software after a first granularity of encrypted or decrypted transaction size has been reached in response to a request by the software to be notified after reaching the first granularity. Example 6 includes the apparatus of example 1, wherein the two or more incoming packets are fragmented or unaligned for Advanced Encryption Standard (AES) encryption or AES decryption. Example 7 includes the apparatus of example 1, wherein the two or more incoming packets are each to have a lower size than 16 bytes. Example 8 includes the apparatus of example 1, the plurality of incoming packets have a size to be determined at boot time or design time. Example 9 includes the apparatus of example 1, wherein at least one of the plurality of incoming packets is 16 bytes. Example 10 includes the apparatus of example 1, wherein the cryptographic logic circuitry is to encrypt or decrypt the two or more incoming packets. Example 11 includes the apparatus of example 1, wherein the cryptographic logic circuitry is to encrypt or decrypt the two or more incoming packets in accordance with Advanced Encryption Standard (AES). Example 12 includes the apparatus of example 1, wherein the cryptographic logic circuitry is to encrypt or decrypt the two or more incoming packets in accordance with Advanced Encryption Standard (AES) in XEX-based Tweakable-codebook mode with ciphertext Stealing (XTS) mode. Example 13 includes the apparatus of example 1, wherein the memory comprises one or more of: SRAM (Static Random Access Memory), MRAM (Magnetoresistive Random Access Memory), and DRAM (Dynamic Random Access Memory. Example 14 includes the apparatus of example 1, wherein the cryptographic logic circuitry is to store a transaction identifier corresponding to the two or more incoming packets in a buffer. Example 15 includes the apparatus of example 14, wherein the memory comprises the buffer. Example 16 includes the apparatus of example 1, wherein the cryptographic logic circuitry is to notify the software after encrypting or decrypting the two or more incoming packets.

Example 17 includes one or more computer-readable medium comprising one or more instructions that when executed on at least one processor configure the at least one processor to perform one or more operations to: cause cryptographic logic circuitry to receive a plurality of incoming packets; and cause the cryptographic logic circuitry to store two or more incoming packets from the plurality of incoming packets in memory, wherein the cryptographic logic circuitry is to inform software in response to detection of the two or more incoming packets. Example 18 includes the one or more computer-readable medium of example 17, further comprising one or more instructions that when executed on the at least one processor configure the at least one processor to perform one or more operations to cause memory to be accessible by the cryptographic logic circuitry and inaccessible by the software. Example 19 includes the one or more computer-readable medium of example 17, further comprising one or more instructions that when executed on the at least one processor configure the at least one processor to perform one or more operations to cause the software to indicate to the cryptographic logic circuitry whether to drop one or more transactions to be received after the two or more incoming packets or to process the two or more incoming packets out-of-order and continue to process the one or more transactions. Example 20 includes the one or more computer-readable medium of example 17, further comprising one or more instructions that when executed on the at least one processor configure the at least one processor to perform one or more operations to cause the cryptographic logic circuitry to receive the two or more incoming packets out-of-order.

Example 21 includes an apparatus comprising means to perform a method as set forth in any preceding example. Example 22 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In various embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
memory coupled to cryptographic logic circuitry; and
the cryptographic logic circuitry to receive a plurality of incoming packets and store two or more incoming packets from the plurality of incoming packets in the memory,
wherein the cryptographic logic circuitry is to inform software in response to detection of the two or more incoming packets.

2. The apparatus of claim 1, wherein the memory is accessible by the cryptographic logic circuitry and inaccessible by the software.

3. The apparatus of claim 1, wherein the software is to indicate to the cryptographic logic circuitry whether to drop one or more transactions to be received after the two or more incoming packets or to process the two or more incoming packets out-of-order and continue to process the one or more transactions.

4. The apparatus of claim 1, the cryptographic logic circuitry is to receive the two or more incoming packets out-of-order.

5. The apparatus of claim 1, wherein the cryptographic logic circuitry is to notify the software after a first granularity of encrypted or decrypted transaction size has been reached in response to a request by the software to be notified after reaching the first granularity.

6. The apparatus of claim 1, wherein the two or more incoming packets are fragmented or unaligned for Advanced Encryption Standard (AES) encryption or AES decryption.

7. The apparatus of claim 1, wherein the two or more incoming packets are each to have a lower size than 16 bytes.

8. The apparatus of claim 1, the plurality of incoming packets have a size to be determined at boot time or design time.

9. The apparatus of claim 1, wherein at least one of the plurality of incoming packets is 16 bytes.

10. The apparatus of claim 1, wherein the cryptographic logic circuitry is to encrypt or decrypt the two or more incoming packets.

11. The apparatus of claim 1, wherein the cryptographic logic circuitry is to encrypt or decrypt the two or more incoming packets in accordance with Advanced Encryption Standard (AES).

12. The apparatus of claim 1, wherein the cryptographic logic circuitry is to encrypt or decrypt the two or more incoming packets in accordance with Advanced Encryption Standard (AES) in XEX-based Tweakable-codebook mode with ciphertext Stealing (XTS) mode.

13. The apparatus of claim 1, wherein the memory comprises one or more of: SRAM (Static Random Access Memory), MRAM (Magnetoresistive Random Access Memory), and DRAM (Dynamic Random Access Memory.

14. The apparatus of claim 1, wherein the cryptographic logic circuitry is to store a transaction identifier corresponding to the two or more incoming packets in a buffer.

15. The apparatus of claim 14, wherein the memory comprises the buffer.

16. The apparatus of claim 1, wherein the cryptographic logic circuitry is to notify the software after encrypting or decrypting the two or more incoming packets.

17. One or more computer-readable medium comprising one or more instructions that when executed on at least one processor configure the at least one processor to perform one or more operations to:
cause cryptographic logic circuitry to receive a plurality of incoming packets; and
cause the cryptographic logic circuitry to store two or more incoming packets from the plurality of incoming packets in memory,
wherein the cryptographic logic circuitry is to inform software in response to detection of the two or more incoming packets.

18. The one or more computer-readable medium of claim 17, further comprising one or more instructions that when executed on the at least one processor configure the at least one processor to perform one or more operations to cause memory to be accessible by the cryptographic logic circuitry and inaccessible by the software.

19. The one or more computer-readable medium of claim 17, further comprising one or more instructions that when executed on the at least one processor configure the at least one processor to perform one or more operations to cause the software to indicate to the cryptographic logic circuitry whether to drop one or more transactions to be received after the two or more incoming packets or to process the two or more incoming packets out-of-order and continue to process the one or more transactions.

20. The one or more computer-readable medium of claim 17, further comprising one or more instructions that when executed on the at least one processor configure the at least one processor to perform one or more operations to cause the cryptographic logic circuitry to receive the two or more incoming packets out-of-order.
